(19) United States
(12) Patent Application Publication
(10) Pub. No.: US 2002/0023788 A1
(43) Pub. Date: Feb. 28, 2002

(54) Multipurpose all-terrain vehicle

(75) Inventors: Mel Torrie, Wellsville, UT (US); Mitch Torrie, Logan, UT (US); Brett Thayn, Logan, UT (US)

Correspondence Address: Clifton W. Thompson, THORPE, NORTH & WESTERN, L.L.P., P.O. Box 1219, Sandy, UT, 84091-1219, US

(73) Assignee: Utah State University

(21) Appl. No.: 09/875,790

(22) Filed: Jun. 6, 2001

Related U.S. Application Data
(60) Provisional application No. 60/210,179, filed on Jun. 6, 2000.

(51) Int. Cl. B62D 55/04

(52) U.S. Cl. 180/9.26; 180/9.62

(57) ABSTRACT

A locomotion system for use in an all terrain vehicle. The system is configured to enable emulation of one or more of three modes of propulsion, including wheeled propulsion, walking propulsion and track propulsion. The system includes multiple selectively rotatable bogies having terrain-engaging elements that are capable of independent rotation with respect to the vehicle and the bogies.

### SPECIFICATION

This invention claims priority of U.S. Provisional Application No. 60/210,179, filed Jun. 6, 2000, the disclosure of which is hereby incorporated herein by reference.

### BACKGROUND OF THE INVENTION

This invention relates to vehicles. More specifically, the invention relates to vehicles adapted to negotiate a wide variety of terrain in a wide variety of environments.

1. Description of Related Art

Vehicles designed to “go anywhere” have been the subject of much interest. Such vehicles have applications in search and rescue, police work, space exploration, and hazardous materials handling. For example, exploring, observing, and retrieving objects from places otherwise difficult or impossible to reach otherwise can require such a specialty vehicle. Such vehicles can be human carrying, or may be remotely controlled and/or include programmed or artificially intelligent control systems, allowing the vehicle to be completely or partially self-guided. The remotely controlled or self-guiding vehicles can include sensors, including visual sensors allowing a remote operator, or control software including artificial intelligence, to guide the vehicle and to observe the environment, and can send back or store data documenting the environment. The vehicle can also include acoustic and/or radio frequency detection/location equipment supplementing or substituting for visual sensors; and such sensing equipment can characterize the terrain and the environment in assisting in guiding the vehicle.

Furthermore, such a vehicle can carry temperature and chemical sensors for further characterizing the environment. Moreover, such vehicles can include a variety of peripheral equipment to perform a variety of tasks. For example, a robotic manipulator, communication devices to allow voice and/or visual communication with persons at a remote location accessed by the vehicle, a disrupter, or other device for destroying or rendering harmless explosive devices, weapons, other sensing equipment such as an x-ray device, a bin or compartment for carrying food and supplies, and other peripherals, depending on the mission the vehicle is performing.

As can be appreciated, such robotic self-guided or remotely controlled vehicles are particularly useful in harsh environments, and in public safety applications such as use by police bomb squads to locate and dispose of bombs. Fire departments can use such vehicles in hazardous fire situations. Such vehicles can be used by FEMA or other government agencies after a disaster to explore and locate victims in hazardous damaged buildings. In this latter example, small vehicles can access places in rubble where humans may not be able to go due to the small size possible with remote-control vehicles. Police can use such vehicles in particularly dangerous situations, such as hostage negotiations where communication device such as a telephone or radio, or food, water or medicine, etc. may be delivered to perpetrators or hostages.

In all the above examples, vehicles used for these purposes need to have exceptional mobility to negotiate curbs, stairs, walls, uneven rubble surfaces, and other obstacles.

Furthermore, in other applications for such vehicles, such as high radiation environment, high temperature environments or toxic environments, the vehicles may need to have particular properties to survive in the environment. For example, vehicle components can be made of chemically inert materials, some electronic components which otherwise may be sensitive to radiation may need to be shielded, and/or vehicle components may need to be thermally isolated from high temperatures, and exterior components obviously will need to be formed of materials tolerant of high temperatures if the vehicle is to be used in such high temperature environments. Given these broad design objectives which are sometimes conflicting, designers of vehicles for these purposes often customize their construction for a particular application. Alternatively, vehicles are built with a view to being as adaptable as possible to a number of different environmental and terrain challenges. The objective in the latter case is to make the vehicle as capable as possible over a wide range of applications, but this may limit its application to certain tasks due, for example, to tipping, or due to complexity coupled with high cost.

One primary consideration in design of such vehicles is the methodology employed for locomotion. Particularly in a class of vehicles which are designed to have wide application in a number of various challenging environments and locations, is being able to negotiate a variety of terrain is very important.

Among vehicles large enough to carry a human operator, a variety of locomotion methodologies are employed. One common arrangement is to provide four wheels adjacent a vehicle frame and connected thereto by suspension which allows considerable wheel travel and shock absorption. Such vehicles can be powered through two or all four wheels in common embodiments. Off-road or “sport-utility” vehicles from very small (essentially four wheel motorcycles) to very large carrying up to nine passengers are common and widely commercially available for recreational and other transportation uses in addition to search and rescue and other applications where negotiation of rough terrain and/or water or mud-covered terrain are implicated. Limiting the scope of consideration to land vehicles, as helicopters and other aircraft and watercraft obviously provide access to otherwise inaccessible locations, other vehicles carrying human operators for specialized applications include military vehicles such as armored personnel carriers and tanks which are adapted to harsh battlefield conditions and negotiation of a variety of terrains in a variety of weather conditions. Such vehicles, in addition to using wheels, can employ endless treadbelts, or tracks, around supporting wheels. This arrangement increases traction, mitigates the difficulty of negotiating uneven terrain, and allows such vehicles to operate in conditions over terrain which was not possible to negotiate before their invention.

In the case of tracked vehicles, whether large or small, steering is generally accomplished by differentially speeding and slowing one track with respect to another. One track being disposed on each side of the vehicle, slowing one with respect to the other will cause the vehicle to divert from a straight course and turn in a desired direction, or even turn in place, as is well understood by those skilled in the art.

In general, wheeled vehicles are more easily maneuverable, in that they have less skidding sideways of the terrain engaging element, namely a wheel instead of a track. Wheeled vehicles which include four or six wheels of which two, four, or six may be independently steerable, are known; and provide exceptional directional maneuverability. Some of these vehicles can also literally turn in place to assume a new directional orientation.

Tracked vehicles, on the other hand, are burdened by the necessity to steer by differentially applying power to the tracks, essentially by dragging one track or applying more power to one track than another; generally do not have tight turning radiuses when traveling at a reasonable speed. While some tracked vehicles can turn fairly tightly, by locking one tread and applying power to the other, or by reversing the directions of one with respect to the other. This may nevertheless be impossible in some situations, because the terrain on which the vehicle rests does not allow the “locked” tread oppositely turning treads to slide sidewise. For example, this maneuver is unlikely to be successful on a surface of interlocked concrete rubble and reinforcing bar.

In particularly uneven terrain, remotely controlled vehicles which use a walking means of locomotion, such as spider-like legs which extend up and down as well as laterally front to back or side to side have been developed. Examples are known which can climb stairs, for example, or more readily negotiate uneven terrain such as a boulder field or rubble strewn surface. Additionally, vehicles which have rotating flails or “walking legs” which may include three or more “legs” extending outwardly from a central rotating hub can be employed. Such a system is a hybrid of a walking vehicle and a wheeled vehicle. Nevertheless, due to the particular configuration, these vehicles can negotiate stairs and uneven terrain better than wheeled vehicles and tracked vehicles in some situations. Nevertheless, such walking locomotion means generally imply a slow speed of movement for the vehicle. Rotating walking legs can travel faster, but provide a very rough ride at a speed above a very slow and deliberate rotation of the walking legs. Such a slow movement, or rough ride, can be very undesirable in applications where a human operator is carried, speed is required, and/or the payload or instruments carried by the vehicle can be damaged by excessive shock and vibration.

### SUMMARY

It has been recognized that it is desirable to provide a vehicle which has improved locomotion characteristics enabling it to negotiate a wider variety of terrain. Such a vehicle will have applications in a wide variety of endeavors as discussed above. It has further been recognized that each of the major groupings of locomotion system types (walking vehicles, wheeled vehicles, and tracked vehicles) have strengths and weaknesses, and are sometimes mutually exclusive as to those strengths and weaknesses. It would be desirable to have a vehicle which incorporates a locomotion system that would enable it to take advantage of the strengths of the various systems, and mitigate somewhat the disadvantages of known locomotion systems.

The present invention accordingly provides a propulsion configuration adapted for traversing a multiplicity of surface types including a frame, a multiplicity of rotatable bogies, each bogie being rotatably connected to the frame and configured to be controllably independently rotated with respect to the frame. Each bogie includes a terrain-engaging element, which can include an endless track or a series of wheels. The bogies are configured so that rotation of each bogie with respect to the frame is also controllably independent of rotation of each terrain-engaging element. These bogies are configured so as to enable the vehicle to emulate at least two of three propulsion modes consisting of walking, wheeled, and track propulsion modes.

This system provides a number of advantages. By rotating the bogies but not the terrain-engaging element, the vehicle can be made to locomote in nearly pure walking mode. By a combination of walking and rotation of the terrain engaging element, the vehicle's capabilities can be extended, to negotiate terrain which is not possible to negotiate with either a tracked vehicle system alone, or a walking system alone. As will be appreciated, the rotating bogies with rotating terrain-engaging elements can provide a combination of walking and translating motion with respect to the ground. This allows the vehicle to extend upward, walk over, and pull itself over, obstacles which would otherwise be difficult or impossible to negotiate.

Furthermore, by a combination of rotation of the bogies rotational orientation with respect to the frame on one side and not the other, or on the front, and not the back, or by differential rotational orientation side to side or front to back, the vehicle frame can be kept approximately level, while the vehicle is negotiating sloped terrain either sideways or front to back. As can be appreciated, this can be very important in a large vehicle where human occupants are to be carried, or, in other applications where sensitive equipment which is optimally kept level, or video sensors are included which would be otherwise required to be gimble-mounted to enable the operator to maintain a level view of the environment and terrain being negotiated.

Moreover, the vehicle locomotion system can be adapted, by use of software and a joystick control, for selected tilting of the vehicle (or leveling on uneven ground) to better control the vehicle remotely.

In another more detailed aspect, the forward and reverse speeds of the vehicle can be greatly enhanced by turning the bogies to an inclined or vertical orientation position to minimize terrain engaging element contact with the ground. In this mode, only very small portions of the terrain engaging elements are brought to a stop in ground contact during vehicle motion, compared with a large portion of the terrain-engaging element remaining in contact in a track mode. Thereby a reduction in rolling resistance is obtained when this “wheel” mode is compared with a purely track mode where all four bogies are aligned horizontally and terrain engaging element contact with the ground surface is maximized.

In the track mode, where all bogies are aligned parallel with the long direction of the frame, it will be apparent that a minimal forward and rear cross-section of the vehicle is presented. In applications where negotiations through small openings is required, if the payload carried by the vehicle is likewise reduced to a minimum so as to fit within the frame, all of the advantages in mobility over varied terrain are retained while gaining the additional advantage of a small cross-section to fit through small openings. This has application in particular in exploration of rubble after a disaster, for example.

Further details and advantages will be apparent with reference to the accompanying drawings and the following detailed description, which illustrate, by way of example, features of the invention.

### DESCRIPTION OF THE DRAWINGS

FIG. 1 is a schematic perspective view of a vehicle in accordance with principles of the invention;

FIG. 2 is another embodiment of the vehicle shown in FIG. 1 with bogies aligned in a wheeled locomotion mode;

FIG. 3 is a schematic perspective view of a partial internal arrangement of the vehicle shown in FIG. 1 in one embodiment, numerous elements are not shown for clarity of presentation of the elements illustrated;

FIG. 4 is a top view of a vehicle shown in FIG. 3 showing further detail, being a photograph of a vehicle arranged in accordance with FIG. 3;

FIG. 5 is a side perspective view of the vehicle shown in FIG. 4;

FIG. 6 is a front view (or rear view, they are mirror image) of the vehicle shown in FIG. 5;

FIG. 7 is a schematic side elevation view of a bogie assembly in another embodiment in accordance with principles of the invention;

FIG. 8 is a schematic perspective view of a portion of the bogie assembly of FIG. 7;

FIG. 9 is a schematic side elevation view of a bogie assembly in another embodiment;

FIG. 10 is a top view of the bogie assembly shown in FIG. 9;

FIG. 11 is a schematic illustration of another embodiment of the invention as viewed from the side;

FIG. 12 is a side perspective view of another embodiment of the invention;

FIG. 13 is a side perspective view of another embodiment of the invention;

FIG. 14 is a schematic side elevation view of a bogie assembly in another embodiment in accordance with principles of the present invention;

FIG. 15 is a schematic top view of the alternate embodiment shown in FIG. 14.

FIG. 16 is a schematic side elevation view of a bogie assembly in another embodiment in accordance with principles of the present invention;

FIG. 17 is a schematic top view of the alternate embodiment shown in FIG. 14.

### DETAILED DESCRIPTION

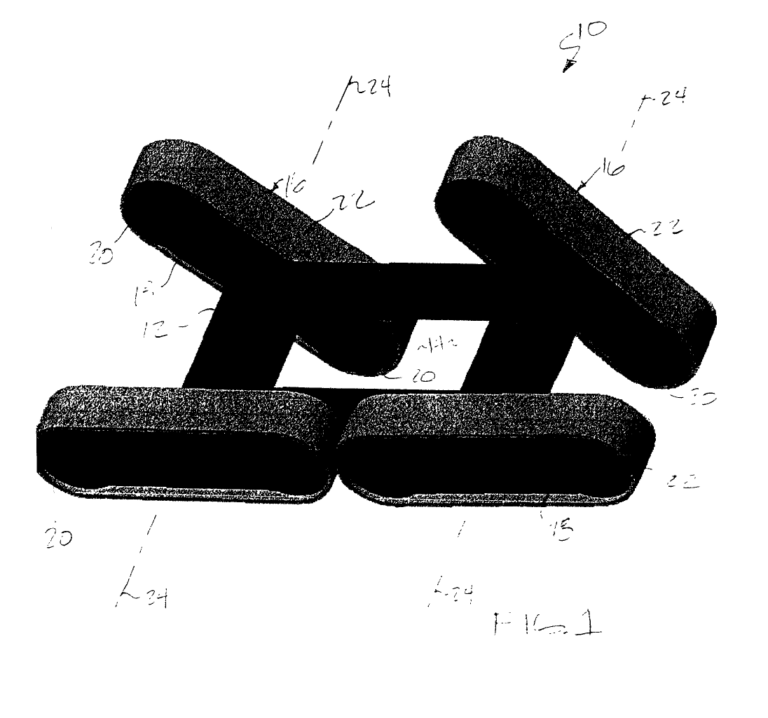

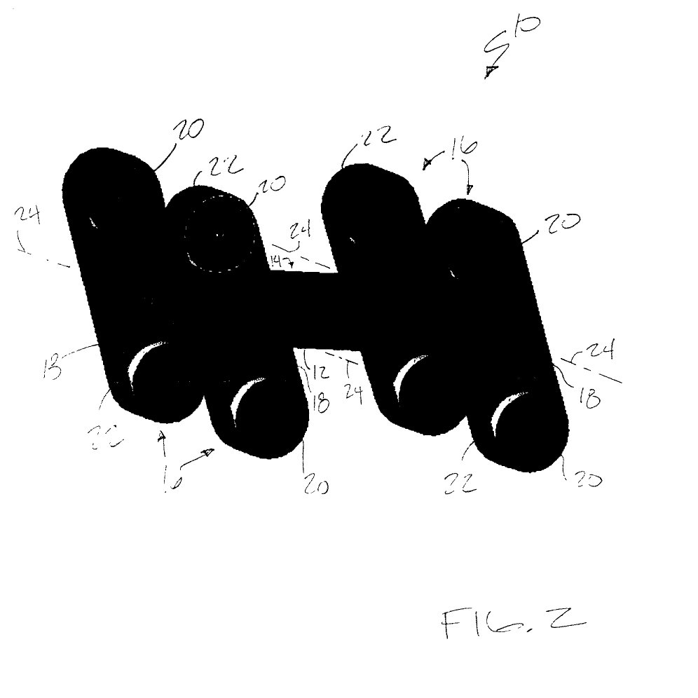

With reference to FIGS. 1 and 2 of the drawings, which are given by way of example and not by way of limitation, the invention is incorporated in a vehicle 10 further comprising a frame 12 which supports motors, batteries and control apparatus (not shown) and can further carry peripheral equipment. Such peripheral equipment could include, for example, a robot manipulator, video cameras, a disrupter, or other device for rendering explosives inoperative or disabling a perpetrator, sensors such as chemical sensors, radiation sensors, x-ray equipment, extra batteries for extended duration missions, etc. Preferably such peripherals would be incorporated in a bay 14 within the frame 12. However the peripheral equipment could be otherwise mounted on the frame. One advantage of having the peripheral equipment contained in a bay is that the vehicle can operate at either of two orientations. In other words, there is no up side or down side, and the vehicle can freely flip back and forth. A manipulator carried in the bay preferably would be capable of deploying from whichever side of the frame is on top or bottom as needed.

Rotatably connected to the frame 12 are four bogie assemblies 16. Each bogie assembly incorporates a bogie frame 18 supporting at least two spindles 20 disposed at opposite ends of the bogie frame. The spindles in turn support an uninterrupted belt, or track 22.

Except for being right/left mirror image mounted, and front/back mirror image mounted, the bogie assemblies are identical in configuration. This simplifies construction. The bogie assemblies are independently rotatable around a central axis 24 in each case. (Hereinafter each of the bogie assemblies will be referred to simply as a “bogie”). Because each of the bogies can be rotated independently, the vehicle can be made to pitch and roll, or to remain level over undulating terrain which tips front to back and sideways.

Furthermore, the tracks 22 of each bogie can be rotated independently of rotation of the bogie itself. This allows further capability in negotiating terrain as the rotation of the bogies in combination with rotation of the track, in each case, allows a combination of walking and rolling motion and action for each of the bogies. This capability is vividly illustrated by the computer animation appended hereto as Appendix 1. This computer animation is incorporated herein in its entirety by reference. As will be appreciated from the foregoing discussion, and the animation of Appendix 1, the vehicle shown in FIGS. 1 and 2 can operate in each of three modes, namely, a tracked mode, a wheel mode, and a walking mode. Furthermore, the vehicle can operate in combinations of two or three of these modes to negotiate terrain to be crossed; and thereby can easily accomplish desired objectives.

As shown also in FIG. 1, a side slope can be negotiated while keeping the vehicle chassis relatively level by rotating the bogies on one side only, as needed, to accommodate the side slope. In this configuration, the bogies shown on the near side of the vehicle on FIG. 1 are operating in track mode while the bogies on the far side of the figure are operating in wheel mode.

With reference to FIG. 2, the vehicle can be converted completely to wheel mode by rotating all bogies so that only a small portion of the tracks on the ends of the bogies 16 (where the spindles 20 are located), contact the ground surface. As will be appreciated, in this mode the vehicle can be literally turned in place by rotating the tracks on one side of the frame in a first direction, and rotating the tracks on the opposite side of the frame in a second, opposite, direction.

Further insights into the modes of operation, and advantages that the vehicle can provide will be appreciated with reference to Appendix 2, entitled “White Paper-All-Purpose All-Terrain Robot Chaos” which is hereby incorporated herein by reference in its entirety.

As can be appreciated, the illustrated configuration allows the vehicle 10 to have applications in the areas discussed above, including for example, search and rescue, and i.e. police work, including swat team and bomb squad missions. Further, the vehicle can be used to explore dangerous rubble in partially or completely collapsed buildings. Fire departments can employ the vehicle to perform assessment, rescue, and fire-fighting duties. The vehicle is also adaptable for use in harsh environments such as hazardous materials work, high radiation environments, and other applications where remote or robotic vehicles can be used to accomplish missions without further endangering human life.

A number of different ways to provide for independently rotating the bogies 16 and the individual tracks 22 can be employed. One feature that would be advantageous for such a system is that the position of the bogies with respect to the frame be lockable. This would enable the bogies to be rotated to a particular position and then left in that position without further drawing power to maintain the position. Moreover, it would be further be advantageous if the rotation of the bogies 16 around their respective bogie axis 24 was selectively lockable. In this way, in one aspect of track mode, the bogies could be allowed to be self-adjusting, or terrain following, being allowed to be freely rotatable, to maximize the surface area of the tread 22 of each bogie 16 on a ground surface (not shown). Further details regarding examples of implementation will be set forth below.

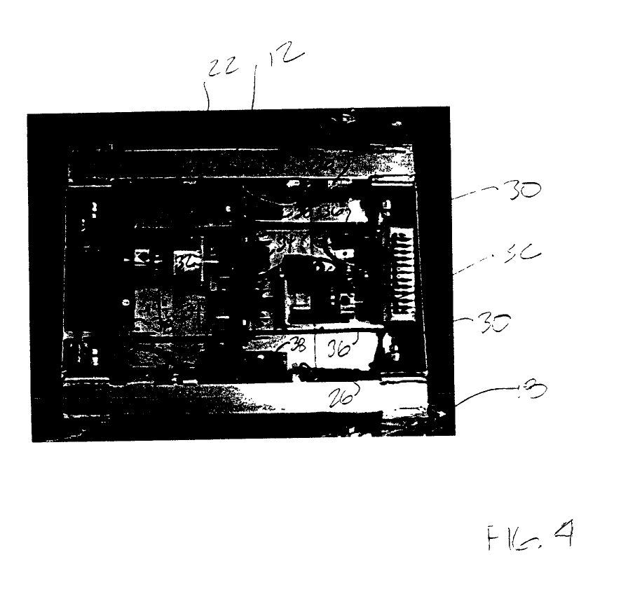

With reference to FIGS. 3, 4, 5, and 6, in one embodiment the internal arrangements of the vehicle 10 include a bogie motor 26 operatively coupled through a bogie gearbox 28 to bogie frames 18 of each of the bogies 16 to provide for individual rotation of each of the bogies. In one embodiment, this connection comprises a worm gear (not shown) which makes the bogies self-locking in the position to which they are turned by the bogie motors 26, as the bogie motor in each case cannot be backdriven through the worm gear. In an alternative embodiment, an electric brake or clutch (not shown) is provided in the operative connection of the gearbox 28 to the bogie frame 18 in each case. This allows selective locking and unlocking of the bogies for free rotation or positioning for movement as described above. As will be appreciated, mechanical interlocks or other means for selectively locking the position of the bogie frame 18 with respect to the vehicle chassis frame 12 can be substituted.

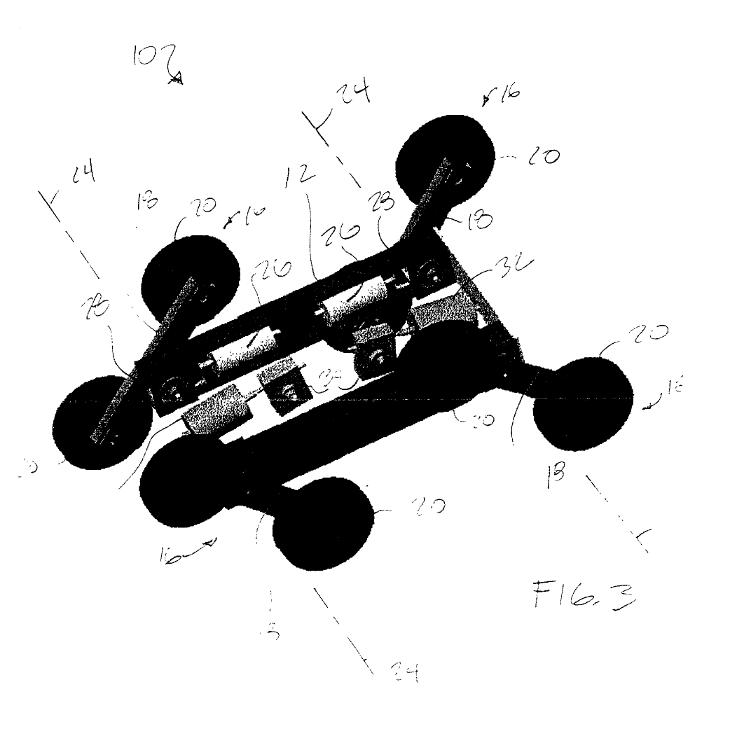

The operative connection of the bogies 16 to the frame 12 includes a bogie drive spindle (not shown) disposed in each case on the bogie axis 24. Co-axial with this spindle is a drive shaft 30 (best appreciated with reference to FIG. 4) which extends through the bogie drive spindle into each of the bogies 16, and is operatively coupled to the spindles 20 to drive them. In one embodiment, this connection is via a chain, which is not visible in the figures, but which is driven by the drive shaft 30 and rotates chain sprockets (not shown) which drive each spindle 20, which in turn drive the tracks 22 as described above. This chain is disposed within the bogie frame 18 and is hidden from view.

In the illustrated embodiment shown in FIGS. 3-6, the tracks are not completely independent. The bogie tracks on one side of the vehicle 10 are driven by a first track drive motor 32 and track gearbox 34, while the bogies on the opposite side of the vehicle are independently driven by an identical track drive motor and gearbox. Drive chains 36 (best appreciated in FIG. 4) couple the track gearbox 34 outputs to the drive shafts 30.

In this illustrated embodiment, the respective opposite sides of the vehicle can be independently actuated by the bogies on the respective sides, which allow the vehicle to turn, for example, but a more preferred embodiment would allow independent motion of each of the bogie tracks, which would also allow the front bogie tracks to move at a different speed than the rear bogie tracks. In the latter arrangement (not shown) this may have the advantage of enhancing the ability of the vehicle to walk and crawl cooperatively to pull itself up and over an obstacle. For example, it may be desirable to move the rear bogies at a slower speed than the front bogies in doing so, as the rear bogies are moving the back side of the vehicle toward the obstacle while the front bogies are pulling the front of the vehicle both toward the object and also upward and over it.

With reference to FIGS. 4, 5, and 6, it will be appreciated that the illustrated embodiment does not allow ample room in the bay 14 for peripherals, as the space is needed for drive motors, batteries, and control electronics. Nevertheless, there is ample additional room for a number of peripherals. However, large peripherals such as a robotic manipulator, a disrupter, etc., would need to be extended out of the bay 14 or mounted outside the frame 12.

Electronics, 38, comprising motor controllers, vehicle guidance and control circuits, receivers and transmitters in remotely controlled vehicles having a radio frequency communications link, for example, processors, logic and memory, for on-board control of vehicle functions can also be included. Furthermore, the vehicle can include gyroscopes, or other inertial navigation devices for control of the vehicle and/or automatic leveling of the frame 12. These components facilitate the functionality of the vehicle desired, as described above.

Also, an encoder (not shown) can be incorporated in the vehicle at each bogie to give feedback of the position of each bogie 16 with respect to frame 12. The encoder is conventional, and encoders giving a digital signal indicative of rotational position are widely commercially available. Further, encoders can be used in each of the bogies to sense track movement. Such encoders (not shown) could sense rotation of the spindles 20 of the bogies, or could be linear encoders disposed on the track 22 and bogie frame 18 to monitor relative movement, whereby movement of the track itself can be confirmed. The latter is advantageous in that a failure between the drive shaft 30 and the track causing the track to fail to rotate, even though the drive shaft is rotating, can be detected. The concept of using encoders to give control feedback of the position of the various elements of the bogies has application not only in this embodiment but in all embodiments disclosed herein.

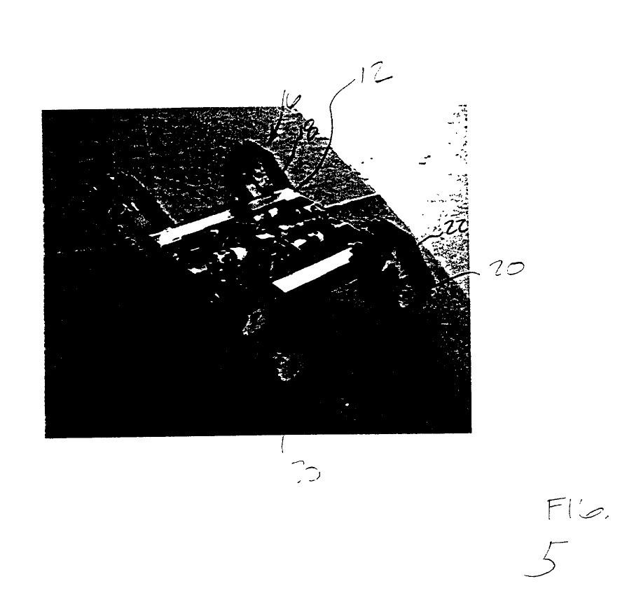

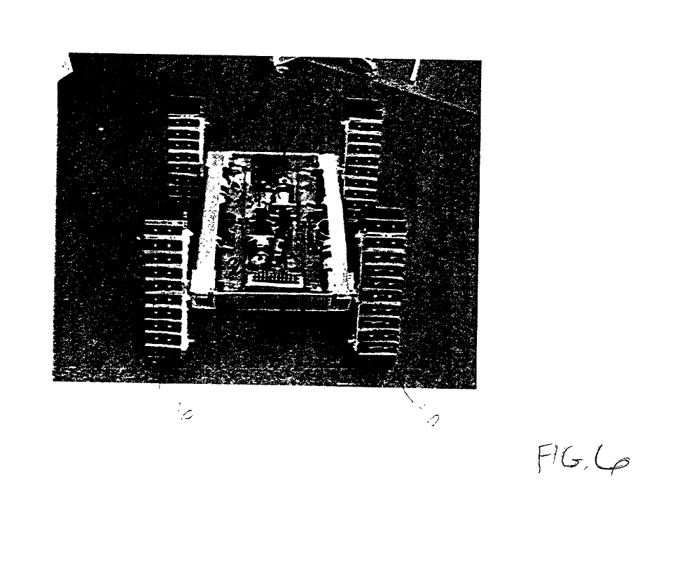

Referring now to FIGS. 7 and 8, in another embodiment, the bogies 16 are each independently actuatable by providing a fixed spindle 38 rigidly attached to the frame (12 in FIG. 1) and mounting drive motors 40, 42 in the bogie 16 itself to actuate the bogie frame 18 and the track 22, respectively.

The bogie 16 is rotated around the fixed spindle 38 by a worm 44 through a gearbox 46. The bogie frame drive motor can be positioned as shown, or disposed at right angles thereto (40′).

Power for both drive motors, 40, 42, can come through the stationary bogie spindle 38 via a mercury slip ring 48 which is conventional and commercially available. Multiple channels (a six channel slip ring can be used) in the slip ring allow connection not only of the drive motors, but also encoders (not shown) discussed above. Power to the motors, 40, 42, can also be supplied by a power source (not shown), such as a battery, mounted on the bogie frame.

The track drive motor 42 is operatively coupled to the track via gearbox 50, the output of which can be coupled to the spindles 20 and track 22 by a drive gear 52. As can be appreciated, a chain coupling the output of the gearbox 50 to one or both sprockets 20 (not shown) could alternatively be provided.

As discussed above, provision of the worm and geared fixed spindle 38 provides automatic locking of the bogie 16 with respect to the frame (12 in FIG. 1). Selective free rotation of the bogie can be provided by allowing selective rotation of the (otherwise) fixed spindle 38 with respect to the frame. This can be accomplished in accordance with the discussion above by providing an electric brake or clutch, or by a selective mechanical interlock.

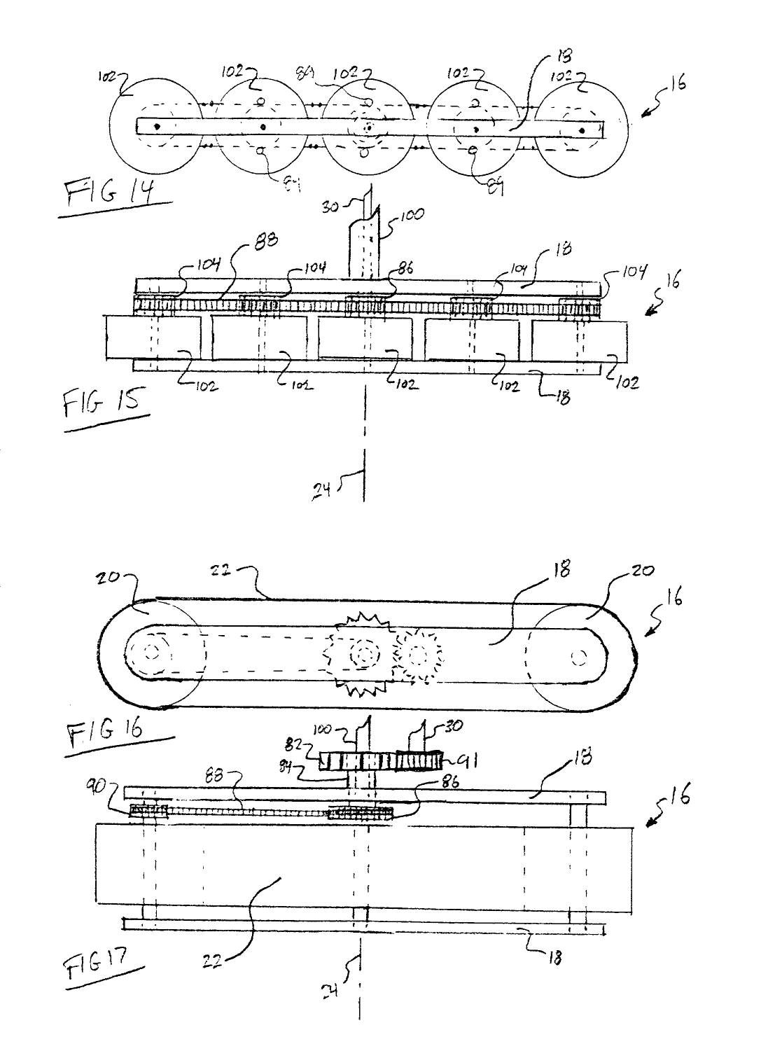

Referring now to FIGS. 16 and 17, an alternate method of individually actuating the bogies is shown. A bogie 16 is shown with a drive shaft 100 that is rotatable with respect to the vehicle frame (not shown). The drive shaft 100 is rigidly attached to the bogie frame 18 to enable rotation of the bogie 16. A slip gear 82 is fixed to a slip collar 84, which is fixed to a sprocket gear 86. The slip assembly, comprised of slip gear 82, slip collar 84 and sprocket gear 86, can rotate independently of the drive shaft 100, allowing independent rotation of the bogie, driven by drive shaft 100, with respect to rotation of the track, driven by drive shaft 30 and drive gear 91. Sprocket gear 90 is fixed to either or both spindles 20, and is coupled to sprocket gear 86 via a chain 88. Either or both spindles 20 then drive track 22, which engages the terrain to propel the vehicle. This embodiment allows for the use of parallel drive shafts 30 and 100 without necessitating extending one drive shaft through the other. As will be appreciated, control of the motors actuating the bogie 16 and terrain-engaging element 22 are coordinated, as in the other embodiments. Also, the bogie drive and track drive can be interchanged in arrangement (not shown) so that the slip gear 82 is instead fixed to the bogie frame, and the sprocket gear 86 is attached to the shaft 100.

In other embodiments the bogies 16 can be made to be individually actuatable as described above in connection with FIGS. 7 and 8, but with a slightly different mechanical arrangement. As will be appreciated, the methodologies discussed herein are only exemplary, and other ways of implementing the functionality described above can be used.

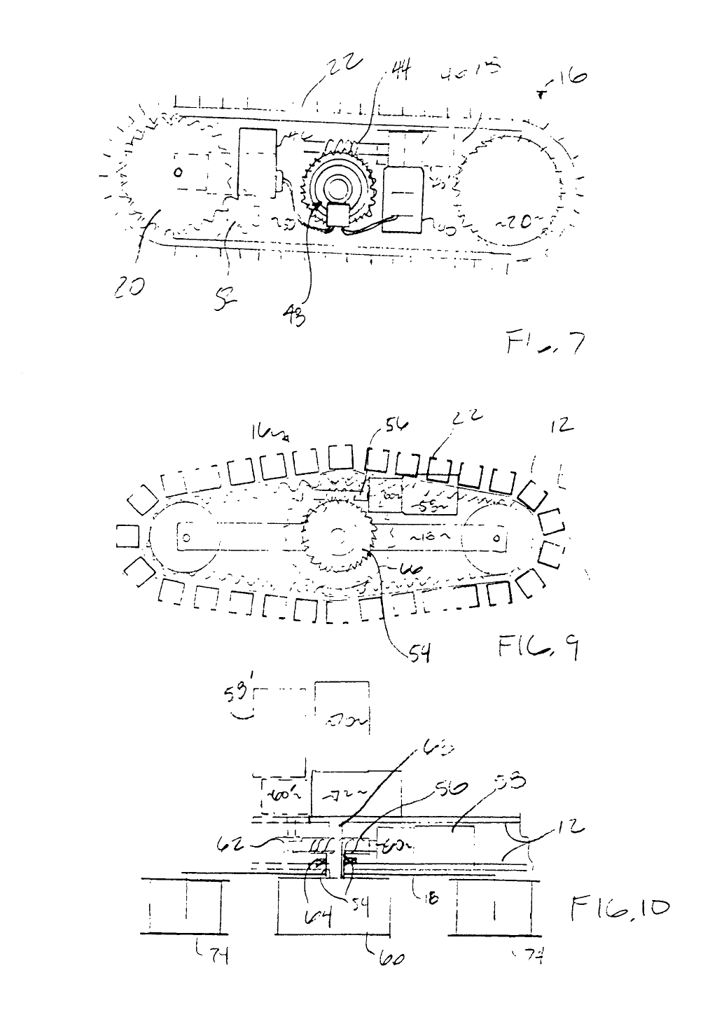

With reference to FIGS. 9 and 10, the bogie frame 18 is fixedly coupled to a spindle 54 which is rotatable with respect to the vehicle frame 12. A worm 56 drive motor 58, and gearbox 60 actuate the bogie frame 18 to provide relative rotation with respect to the frame 12 as described above.

An alternative location for the bogie drive motor 58 is shown at 58′. In this latter case, the worm is replaced by small drive gear 62. If a worm is not provided in the gearbox 60′, an electric clutch (not shown) or other locking means will be required to provide the locking functionality described above. As can be appreciated, the locking function can also be provided by disposing the electric brake or clutch between the bogie drive spindle 54 and the frame 12, for example, near the location of a bearing 64 between the drive spindle and the frame.

In this embodiment, a single-track drive spindle 66 is driven via a drive shaft 68 by a track drive motor 70 via gearbox 72. The drive shaft passes through the fixed bogie spindle 54, and rotates independently thereof. Additional spindles 74 are disposed at the ends of the bogie frame 18 and can be free-turning.

As will be appreciated, the embodiment shown in FIGS. 9 and 10 enables independent actuation of each of the four bogies 16, and also allows the drive motors to be mounted inboard of the frame 12. While there are advantages to this latter arrangement, there also are advantages to mounting the drive motors within the bogie itself. While the embodiment of FIGS. 9 and 10 allows somewhat simpler mechanical arrangement by eliminating the need for the mercury slip rings, and by co-axial disposition of this bogie drive and track drive, the embodiment of FIGS. 7 and 8 places the weight of the drive motors on the bogie frame 18 rather than the vehicle chassis proper.

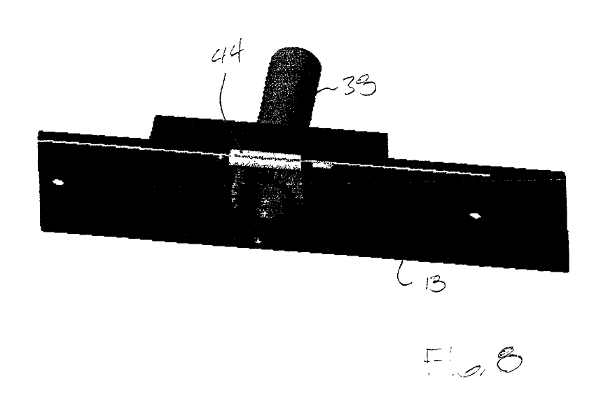

With reference now to FIGS. 11 and 12, it will be appreciated that the foregoing arrangements could also be implemented in a vehicle having six bogies rather than four. This latter arrangement is particularly advantageous in that improved stability in walking mode can be more simply given by moving the bogies into relative positions where from one side of the vehicle to the other they are disposed at right angles, and operating all of the bogies in unison as flails. In this embodiment, for example, a set angular relationship between the bogies (such as 120 degrees) can be provided.

Alternatively, as shown in FIG. 11, the bogies could be made to turn independently to follow terrain in keeping the frame 12 level, while moving forward by operation of the track drives to rotate the tracks providing forward or reverse locomotion (or turning). In this manner, a combination of bogie movement and track movement provides essentially a wheeled mode movement combined with self-leveling provided by the walking action of the bogies. As will be appreciated, this locomotion methodology can also be used with 4-bogie vehicles.

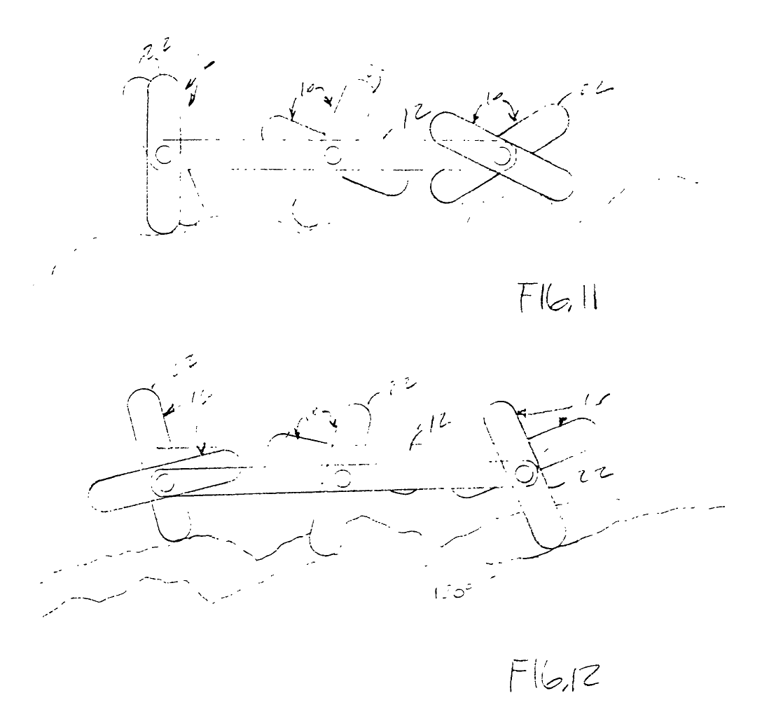

As shown in FIG. 13, and also in the animation of Appendix 1, two vehicles 10 can be coupled in tandem. This is accomplished in one embodiment by a link 76. This link can be configured to allow, or prevent, relative rotational motion between the two vehicles 10. For example, if the two vehicles are rigidly coupled together, additional stability in a flail walking mode is achieved. This is particularly borne out with reference to the animation of Appendix 1. Moreover, by allowing relative rotation about a vertical axis at one or both ends of the link 76 but not rotation around a horizontal axis through the link, linked vehicles could be turned, while maintaining increased stability. Moreover, by allowing relative rotation in vertical and horizontal axes between two linked vehicles, obstacles can be traversed which otherwise would not be overcomeable by a single vehicle 10. For example, two linked vehicles may be able to be controlled so as to climb over a taller vertical barrier than may be possible by one vehicle alone. Linking vehicles also allows for additional payload of peripherals or other desired equipment or supplies.

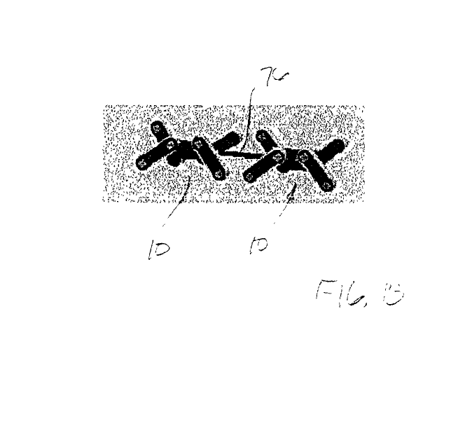

Referring now to FIGS. 14 and 15, an alternate embodiment of the terrain-engaging element is shown. Bogie 16 is fixed to drive shaft 100, which is rotatably coupled to the vehicle frame (not shown). Drive shaft 30, which is coaxial to and contained within drive shaft 100, can rotate independently of drive shaft 100 and bogie 16. Sprocket 86 is fixed to drive shaft 30 to drive chain 88. Idlers 89 ensure engagement of the chain with the sprocket gears 104. Chain 88 is connected to the remaining wheels 102, which are each fixed to a sprocket gear 104 and rotatably connected to bogie frame 18. Each of the wheels 102 are fitted on axles (not shown) that are parallel with drive shaft 30. The wheels 102 act singly and collectively as a terrain engaging element, and each have approximately the same rate of rotation, allowing for emulation of a track terrain engaging element without utilizing a track system.

With respect to all of the embodiments discussed above, variations in arrangement can be made. For example, while embodiments where the drive motors are positioned entirely within the vehicle frame 12, or entirely on the bogies 16, have been disclosed, a combination is also possible. Bogie actuator motors for rotating the bogies can be located within the frame 12, for example, while track actuation motors can be disposed in the bogies 16 themselves. As will be appreciated, this could also be done oppositely, by providing a bogie drive motor as shown in FIGS. 7 and 8, for example, and running a track drive shaft through the spindle 66 to actuate the track 22 itself in a manner such as that shown in FIGS. 3 through 6, or 9 and 10. Other mechanical combinations are also possible.

Moreover, with respect to all of the foregoing embodiments, walking mode is particularly problematic because in this mode the vehicle must sense the ground to minimize rollovers when traversing rubble or other rough terrain. This can be overcome by placing torque sensors on each bogie. This is then used in a feedback control system which will always try to equalize the applied torque between all four bogies. An open loop method is currently preferred, where a constant voltage is applied to each bogie. Those bogies which contact the surface will slow down under the load, and those not contacting the surface will speed up, and consequently will rotate around to catch up and also contact the ground.

This walking mode can be even more complex by providing track movement in combination with the walking. This is shown, for example, in the animation provided in Appendix 1 (however, independent action of all bogies in combination with independent actuation of the tracks is not shown). Alternatively, coordination of movement of the bogies and tracks front to back, as shown in the animation, can be used. Whether coordinated front to back, side to side, or all four bogies operating independently, a similar control scheme can be used where torque in each of the track drive motors is sensed, and equalized by the control system.

Such methodologies are particularly useful in automated control modes, or where the vehicle is guided by artificial intelligence. However, at some point it may be advantageous to have a human operator intervene, and independently control the movement of the elements. Alternatively, a combination of automatic actuation and human operator control can be used to simplify control for the operator.

The self-leveling functionality, described above, will include sensors to determine pitch and roll of the vehicle. In addition to gyros, accelerometers and/or rate sensors or other inertial sensors can be used. Such sensors are available in many forms, including as solid-state devices, and are widely commercially available. Feedback control can be used to keep the chassis level to the extent possible regardless of the terrain.

Also, as mentioned, the vehicle is invertible. That is to say, in one embodiment there is no particular upside or downside and the vehicle is “floppable” between the two. This is particular to this vehicle, and can be advantageous in particularly difficult terrain, or in descending down over an obstacle, for example, in negotiating a drop-off.

In climbing stairs, or in other difficult terrain negotiation situations, the gyro or other inertial controls are placed in series with the command signals for the tracks, and this compensates via changing voltage to either speed up or slow down the tracks to stay on a straight path up or down the stairs. As will be appreciated, other control methodologies can be employed using sensors for detecting orientation and/or motion of the vehicle.

Parenthetically, a pendulum, or the like, can be substituted for a gyro if the vehicle is not “floppable.”

Further features of the vehicle in accordance with principles of the invention can be appreciated with reference to Appendix 3, which is hereby incorporated herein in its entirety by reference. One aspect of human control of the vehicle, either by a vehicle-borne operator, or a remote operator communicating with the vehicle through a tether or by radio frequency signals or some other means, is that the vehicle can be advantageously controlled by use of joy sticks. As mentioned above, and as shown in the animation, pitch and roll of the vehicle can be controlled by rotation of the bogies, and this can be further implemented by using a joystick. Particulars of an exemplary embodiment of joystick control are set forth in Appendix 3, and also in Appendix 4 which is also incorporated herein in its entirety by reference.

Using multiple joys sticks, and also foot pedals, control inputs can be more intuitively given to the vehicle. For example, one joystick can be used to control pitch and roll, while another joystick could be used to control application of power to the various bogies front to back or side to side. Foot pedals can be used for yaw control, applying more power to the bogie assemblies on one side and the other, or by differentially applying power, or by locking the bogie assemblies on one side while rotating the tracks on the other.

As will be appreciated, vehicle 10 in accordance with the invention provides a number of advantages in negotiating terrain for accessing remote locations, or locations within hazardous environments. The vehicle in accordance with the invention is scalable to be very small and remotely or programably controlled, or can be scaled large enough to accommodate a human operator. Likewise, intelligent control systems can be combined with sensors to provide a measure of self-guidance and control.

Vehicle 10 has capabilities facilitated by the combination of two or more of tracked, walking, or wheeled locomotion modes. This combination of functionality allows more difficult terrain to be traversed than would otherwise be the case. This in turn allows the vehicle to have wider application in reaching locations otherwise inaccessible.

While the invention has been described and shown with reference to particular embodiments, it will be appreciated that the invention can be implemented in a number of ways, and that additional features and functionalities can be incorporated without departing from the spirit and scope of the invention.

What is claimed is:

1. A locomotion system configured for use in an all-terrain vehicle, comprising:
a vehicle frame;
a multiplicity of rotatable bogies, each rotatably coupled to the vehicle frame, the system being configured to enable controllable rotation of the rotatable bogies relative to the vehicle frame; and
wherein each rotatable bogie includes a terrain engaging element, each terrain engaging element being rotatably disposed on a rotatable bogie, the system being configured to enable controllable rotation of each terrain engaging element substantially independent of relative rotation of the rotatable bogie and the vehicle frame.

2. A system as in claim 1, wherein the terrain engaging element comprises an endless track, configured to engage the terrain and enable selective locomotion of the rotatable bogie.

3. A system as in claim 2, each of the multiplicity of rotatable bogies further comprising:
a) a bogie frame, rotatably coupled to the vehicle frame; a plurality of track spindles, each rotatably coupled to the bogie frame, a track spindle being configured to propel the endless track;
a track motor, carried by the vehicle frame;
a track gear box, operatively coupled to track motor;
a track drive shaft, operatively coupled to the gear box and a track spindle, the track drive shaft being configured to transfer torque forces generated by the track drive motor to the track spindle; and
wherein the endless track is configured to encircle the plurality of track spindles and the system enable selective locomotion of the rotatable bogie.

4. A system as in claim 2, each of the multiplicity of rotatable bogies further comprising:
b) a bogie frame, rotatably coupled to the vehicle frame;
a plurality of track spindles, each rotatably coupled to the bogie frame;
at least one track motor, carried by the bogie frame;
at least one track gear box, operatively coupled to at least one of the plurality of track spindles and at least one of the track motors, the at least one track gear box being operatively coupled to at least one track spindle, and configured to transfer torque from the track motor to the track spindle; and
wherein the endless track is configured to encircle the plurality of track spindles and enable selective locomotion of the rotatable bogie.

5. The system as in claim 2, further comprising:
c) a bogie spindle fixed to the vehicle frame, the fixed bogie spindle being configured to engage one of the rotatable bogies;
a bogie spindle drive motor, coupled to the bogie frame;
a bogie spindle gear box, operatively coupled to the bogie frame and the bogie spindle drive motor, the bogie spindle gear box being configured to selectively engage the fixed bogie spindle to selectively control rotation of the bogie; and
a brake, coupled to the bogie frame, the brake being configured to selectively lock the bogie in position to selectively prevent rotation of the bogie relative to the frame.

6. The system as in claim 2, further comprising:
d) a bogie spindle, fixed to the vehicle frame, the fixed bogie spindle being configured to engage one of the rotatable bogies; a bogie spindle drive motor, coupled to the bogie frame; and
a bogie spindle worm gear, rotatably coupled to the bogie frame and the bogie spindle drive motor, the bogie spindle worm gear being configured to engage the fixed bogie spindle to control rotation of the bogie and selectively prevent rotation relative to the vehicle frame.

7. The system as in claim 2, further comprising:
e) fixed bogie spindle, fixed to a bogie frame, the fixed bogie spindle being configured to engage the vehicle frame;
a bogie spindle drive motor, carried by the vehicle frame;
a bogie spindle gear box, operatively coupled to the vehicle frame and the bogie spindle drive motor, the bogie spindle gear box being configured to selectively transfer torque from the bogie spindle drive motor to the fixed bogie spindle to selectively control the rotation of the bogie; and
a brake, coupled to the vehicle frame, the brake being configured to selectively lock the bogie in position to selectively prevent rotation of the bogie.

8. The system as in claim 2, further comprising:
f) a fixed bogie spindle, fixed to the bogie frame, the fixed bogie spindle being configured to engage the vehicle frame;
a bogie spindle drive motor, carried by the vehicle frame; and a bogie spindle worm gear, rotatably coupled to the vehicle frame and the bogie spindle drive motor, the bogie spindle worm gears being configured to engage the fixed bogie spindle to control rotation of the bogie and enable a rotational lock between the bogie and the vehicle frame.

9. The system as in claim 1, wherein the terrain-engaging element further comprises a plurality of wheels, each rotatably coupled to a bogie, the plurality of wheels being configured to collectively controllably rotate independently of the relative rotation of the rotatable bogie and the vehicle frame.

10. A locomotion system configured for use in an all terrain vehicle, comprising:
g) a vehicle frame;
at least four rotatable bogies, each rotatably coupled to the vehicle frame, the system being configured to enable individual and controllable rotation of the rotatable bogies relative to the vehicle frame; and
wherein each rotatable bogie includes a terrain engaging element, each terrain engaging element being rotatably disposed on a rotatable bogie, the system being configured to enable controllable rotation of each terrain engaging element substantially independent of relative rotation of the rotatable bogie and the vehicle frame.

11. The system of claim 10, wherein the terrain engaging element comprises an endless track, configured to engage the terrain and enable selective locomotion of the rotatable bogie.

12. The system as in claim 11, each of the at least four rotatable bogies further comprising:
h) a bogie frame, rotatably coupled to the vehicle frame;
a plurality of track spindles, each rotatably coupled to the bogie frame, each track spindle being configured to propel the endless track;
at least one track motor, coupled to the vehicle frame; at least one track gear box, rotatably coupled to the vehicle frame and at least one track motor;
at least one track drive shaft, rotatably coupled to a gear box and a track spindle, the track drive shaft being configured to transfer torque from the track drive motor to the track spindle; and
wherein the endless track is configured to encircle the plurality of track spindles and enable selective locomotion of the rotatable bogie.

13. The system as in claim 11, each of the at least four rotatable bogies further comprising:
i) a bogie frame, rotatably coupled to the vehicle frame;
a plurality of track spindles, each rotatably coupled to the bogie frame;
at least one track motor, coupled to the bogie frame;
at least one track gear box, coupled to the bogie frame and rotatably coupled to at least one of the plurality of track spindles and at least one of the track motors, the at least one track gear box being configured to transfer torque from the track motor to the track spindles; and
wherein the endless track is configured to encircle the plurality of track spindles and enable selective locomotion of the rotatable bogie.

14. The system as in claim 13, further comprising:
j) at least four fixed bogie spindles, each fixed to the vehicle frame, each fixed bogie spindle being configured to engage one of the at least four rotatable bogies;
a bogie spindle drive motor, coupled to the bogie frame;
a bogie spindle gear box, operatively coupled to the bogie frame and the bogie spindle drive motor, the bogie spindle gear box being configured to selectively engage the fixed bogie spindle to selectively control rotation of the bogie; and
a brake, coupled to the bogie frame, the brake being configured to selectively lock the bogie in position to selectively prevent rotation of the bogie.

15. The system as in claim 13, further comprising:
k) at least four fixed bogie spindles, each fixed to the vehicle frame, each fixed bogie spindle being configured to engage one of the at least four rotatable bogies;
a bogie spindle drive motor, coupled to the bogie frame; and
a bogie spindle worm gear, rotatably coupled to the bogie frame and the bogie spindle drive motor, the bogie spindle worm gear being configured to engage the fixed bogie spindle to control rotation of the bogie.

16. The system as in claim 13, further comprising:
l) at least four fixed bogie spindles, each fixed to a bogie frame, each fixed bogie spindle being configured to engage the vehicle frame;
a plurality of bogie spindle drive motors, each coupled to the vehicle frame;
a plurality of bogie spindle gear boxes, each operatively coupled to the vehicle frame and one of the plurality of bogie spindle drive motors, the bogie spindle gear boxes each being configured to selectively transfer torque from the bogie spindle drive motors to the fixed bogie spindle to selectively control the rotation of the bogie; and
a brake, coupled to the vehicle frame, the brake being configured to selectively lock the bogie in position to selectively prevent rotation of the bogie.

17. The system as in claim 13, further comprising:
m) at least four fixed bogie spindles, each fixed to the bogie frame, each fixed bogie spindle being configured to engage the vehicle frame;
a plurality of bogie spindle drive motors, each coupled to the vehicle frame; and
at least four bogie spindle worm gears, each rotatably coupled to the vehicle frame and one of the plurality of bogie spindle drive motors, the bogie spindle worm gears each being configured to engage the fixed bogie spindle to control rotation of the bogie.

18. The system as in claim 10, wherein the terrain-engaging element further comprises a plurality of wheels, each rotatably coupled to a bogie, the plurality of wheels being configured to collectively rotate independently of the relative rotation of the rotatable bogie and the vehicle frame.

19. A locomotion system configured for use in an all terrain vehicle, comprising:
n) a vehicle frame;
at least four rotatable bogies, each rotatably coupled to the vehicle frame, the system being configured to enable individual and controllable rotation of the rotatable bogies relative to the vehicle frame;
wherein each rotatable bogie includes a terrain engaging element, each terrain engaging element being rotatably disposed on a rotatable bogie, the system being configured to enable individual and controllable rotation of each terrain engaging element independent of the relative rotation of the rotatable bogie and the vehicle frame; and
wherein the system is configured to allow the vehicle to emulate at least two of three propulsion modes selected from the group of propulsion modes consisting of walking, wheeled, and track propulsion modes.

20. The system of claim 19, wherein the terrain-engaging element comprises an endless track, configured to engage the terrain and enable selective locomotion of the rotatable bogie.

21. The system as in claim 20, each of the at least four rotatable bogies further comprising:
o) a bogie frame, rotatably coupled to the vehicle frame;
a plurality of track spindles, each rotatably coupled to the bogie frame, each track spindle being configured to propel the endless track;
at least one track motor, coupled to the vehicle frame; at least one track gear box, rotatably coupled to the vehicle frame and at least one track motor;
at least one track drive shaft, rotatably coupled to a gear box and a track spindle, the track drive shaft being configured to transfer torque from the track drive motor to the track spindle; and
wherein the endless track is configured to encircle the plurality of track spindles and enable selective locomotion of the rotatable bogie.

22. The system as in claim 21, each of the at least four rotatable bogies further comprising:
p) a bogie frame, rotatably coupled to the vehicle frame;
a plurality of track spindles, each rotatably coupled to the bogie frame;
at least one track motor, coupled to the bogie frame;
at least one track gear box, coupled to the bogie frame and rotatably coupled to at least one of the plurality of track spindles and at least one of the track motors, the at least one track gear box being configured to transfer torque from the track motor to the track spindles; and
wherein the endless track is configured to encircle the plurality of track spindles and enable selective locomotion of the rotatable bogie.

23. The system as in claim 21, further comprising:
q) at least four fixed bogie spindles, each fixed to the vehicle frame, each fixed bogie spindle being configured to engage one of the at least four rotatable bogies;
a bogie spindle drive motor, coupled to the bogie frame;
a bogie spindle gear box, operatively coupled to the bogie frame and the bogie spindle drive motor, the bogie spindle gear box being configured to selectively engage the fixed bogie spindle to selectively control rotation of the bogie; and
a brake, coupled to the bogie frame, the brake being configured to selectively lock the bogie in position to selectively prevent rotation of the bogie.

24. The system as in claim 21, further comprising:
r) at least four fixed bogie spindles, each fixed to the vehicle frame, each fixed bogie spindle being configured to engage one of the at least four rotatable bogies;
a bogie spindle drive motor, coupled to the bogie frame; and
a bogie spindle worm gear, rotatably coupled to the bogie frame and the bogie spindle drive motor, the bogie spindle worm gear being configured to engage the fixed bogie spindle to control rotation of the bogie.

25. The system as in claim 21, further comprising:
s) at least four fixed bogie spindles, each fixed to a bogie frame, each fixed bogie spindle being configured to engage the vehicle frame;
a plurality of bogie spindle drive motors, each coupled to the vehicle frame;
a plurality of bogie spindle gear boxes, each operatively coupled to the vehicle frame and one of the plurality of bogie spindle drive motors, the bogie spindle gear boxes each being configured to selectively transfer torque from the bogie spindle drive motors to the fixed bogie spindle to selectively control the rotation of the bogie; and
a brake, coupled to the vehicle frame, the brake being configured to selectively lock the bogie in position to selectively prevent rotation of the bogie.

26. The system as in claim 21, further comprising:
t) at least four fixed bogie spindles, each fixed to the bogie frame, each fixed bogie spindle being configured to engage the vehicle frame;
a plurality of bogie spindle drive motors, each coupled to the vehicle frame; and
at least four bogie spindle worm gears, each rotatably coupled to the vehicle frame and one of the plurality of bogie spindle drive motors, the bogie spindle worm gears each being configured to engage the fixed bogie spindle to control rotation of the bogie.

27. The system as in claim 19, wherein the terrain engaging element further comprises a plurality of wheels, each rotatably coupled to a bogie, the plurality of wheels being configured to collectively rotate independently of the relative rotation of the rotatable bogie and the vehicle frame.
